(19) United States
(12) Patent Application Publication
(10) Pub. No.: US 2004/0187902 A1
(43) Pub. Date: Sep. 30, 2004

(54) Portable, disposable vehicle shelter

(76) Inventor: Stephen Goldsmith, Walnut, CA (US)

Correspondence Address: J.W. Gipple, Gipple & Hale, P.O. Box 40513, Washington, DC, 20016, US

(21) Appl. No.: 10/402,292

(22) Filed: Mar. 31, 2003

(51) Int. Cl. E04H 15/06; E04B 1/34; B62D 63/04

(52) U.S. Cl. 135/88.01; 52/3

(57) ABSTRACT

A portable, disposable vehicle shelter is provided. It comprises a bag or body-portion, large enough to fit over and contain the vehicle; and a mechanism to pull the bottom edge of the bag tightly around the bottom of the vehicle.

### FIELD OF THE INVENTION

This invention is directed to an inexpensive, disposable shelter for a vehicle such as an automobile, motorcycle, boat or tank. It comprises a bag or body-portion, large enough to fit over and contain the vehicle; and a mechanism to pull the bottom edge of the bag tightly around the bottom of the vehicle.

### BACKGROUND OF THE INVENTION

A vehicle left on the street, in a parking lot, or anywhere outside a shelter is exposed to weather conditions, as well as blowing dust and grit and splashing water containing salts and other chemicals applied to road surfaces. It can be “dinged” by the opening of doors on adjacent vehicles. It is easily accessible to vandals and thieves. For these, among other reasons, many owners of vehicles choose to use portable shelters to protect such vehicles when left on a street or a parking lot or outside permanent shelters. These portable shelters are of a more or less permanent nature, that is they are made of materials which can stand up and endure over a long period of repeated uses. As a result, they are relatively expensive and bulky.

It is, accordingly, an object of this invention to provide a light weight, inexpensive, disposable shelter for vehicles temporarily left on the street, in a parking lot or anywhere outside a permanent shelter.

### DISCLOSURE OF THE PRIOR ART

Applicant is not currently aware of any prior disclosure of a light weight, inexpensive, disposable protective shelter for vehicles.

### BRIEF DESCRIPTION OF THE DRAWINGS

FIG. 1 is a perspective view of the vehicle shelter applied to a vehicle.

FIG. 2 is a cross-sectional view of the vehicle shelter applied to a vehicle.

### SUMMARY OF THE INVENTION

In accordance with the present invention, an apparatus is provided that comprises a light weight, inexpensive, disposable shelter for a vehicle. The temporary shelter is constructed of a sheet or sheets of vinyl plastic that may be laminated, woven, knitted or mesh. Polyethylene or PVC film can also be used. The gauge of the shelter can be within the range of 0.006 to 0.06 mm. The shelter comprises a simple round bag shape that will fit over any vehicle within a specific generic category (e.g., motorcycle, compact car, SUV, tank). Although the shelter will settle into the shape of the vehicle body it covers, it is not contoured to the shape of that specific vehicle. This has the economic advantage of being able to produce one size of disposable shelter that may be used with a large variety of specific vehicles. Being comprised of light weight material it can be stored without taking up much space nor adding much weight to the vehicle in which it is stored. And, being inexpensive to produce, it can be used once and then discarded.

Along the bottom edge of the shelter, there is provided a means to pull it in tight under the vehicle body. This can be an elastic strip extending around the bottom edge of the shelter, or a draw string that can be drawn taut after the shelter is in place.

The disposable shelter can be produced at minimal cost. It eliminates the need to store heavier, more permanent types of shelter, which are more difficult and awkward to apply to the vehicle, and must be cleaned between uses.

### DETAILED DESCRIPTION OF THE DRAWINGS

Reference will now be made in detail to the preferred embodiment of the invention, as illustrated in the accompanying drawings.

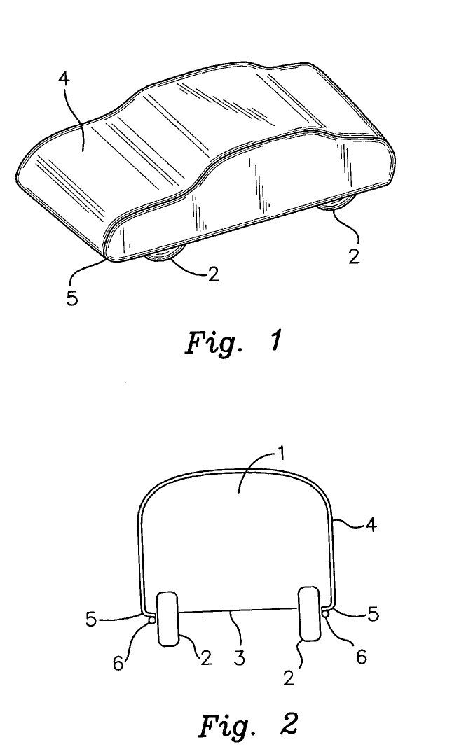

In FIG. 1, the portable, disposable vehicle shelter 4 is illustrated as applied to a compact automobile. Its bottom edge 5 appears above the automobile wheels 2.

FIG. 2, which is a cross-sectional view, illustrates the outer periphery of the automobile 1, its bottom 3 and its wheels 2. The shelter 4 loosely covers automobile 1. Its bottom end 5 falls slightly below the bottom of the automobile 1. Along the terminal edge of the bottom end 5 there is an elastic strip 6 comprised of rubber elements. The circumference of the elastic strip, when not stretched, is less than the circumference of the bottom periphery of the automobile; so when the shelter 4 is drawn down over the automobile 1 its bottom end 5 is elastically pulled in under the automobile 1 by the elastic strip 6.

In an alternative embodiment of the invention (not illustrated in the drawings), the bottom end 5 of the shelter 4 has a draw string that can be drawn taut after the shelter 4 is placed over the automobile 1, pulling the bottom end 5 in under the automobile.

It will be appreciated that by drawing in the bottom end 5 of the shelter 4 under the automobile 1, the shelter is secured in place. It cannot be blown off by a gust of wind nor easily lifted by a casual vandal. One appropriate use of the present invention would be to protect military vehicles such as tanks that are temporarily stored in harsh environments (such as deserts) and subjected to wind storms with dust and grit.

The shelter 4 is comprised of polyethylene film which is 0.015 mm thick. This has been found to be the material which gives the best balance of substance stability while still being light weight and inexpensive.

It will further be apparent to those skilled in the art that various modifications and variations can be made in the portable, disposable vehicle shelter of the present invention without departing from the spirit or scope of the invention. Thus, it is intended that the present invention cover the modifications and variations of this invention provided they come within the scope of the appended claims and their equivalents.

What is claimed is:

1. A portable, disposable vehicle shelter comprising:
a bag shaped body portion of light weight vinyl sheet large enough to contain a vehicle of generic size
a bottom edge of said body portion containing a means to pull said bottom edge in and under the bottom of the vehicle of generic size over which it is extended.

2. The shelter of claim 1, in which the body portion is vinyl sheet in the range of 0.006 to 0.6 mm.

3. The shelter of claim 1, in which the body portion is vinyl sheet of 0.015 mm.

4. The shelter of claim 1, in which the means to pull said bottom edge in and under the bottom of the vehicle is rubber based elasticized material.

5. The shelter of claim 1, in which the means to pull said bottom edge in and under the bottom of the vehicle is a draw string.
